(19) United States
(12) Patent Application Publication
(10) Pub. No.: US 2003/0090085 A1
(43) Pub. Date: May 15, 2003

(54) Trailer hitch with electrical connector

(76) Inventors: Dinesh Seksaria, Novi, MI (US); Robert C. Burdick, Romulus, MI (US); Michael B. Andrzejewski, Livonia, MI (US); John W. Cobes, Lower Burrell, PA (US)

Correspondence Address: ALCOA INC, ALCOA TECHNICAL CENTER, 100 TECHNICAL DRIVE, ALCOA CENTER, PA, 15069-0001, US

(21) Appl. No.: 10/270,942

(22) Filed: Oct. 15, 2002

Related U.S. Application Data
(63) Continuation-in-part of application No. 09/694,590, filed on Oct. 23, 2000, now Pat. No. 6,464,240.
(60) Provisional application No. 60/329,799, filed on Oct. 16, 2001.

(51) Int. Cl. B60D 1/00

(52) U.S. Cl. 280/495

(57) ABSTRACT

A vehicle trailer hitch including an aluminum tubular U-shaped strut and a cast aluminum receiver mounted thereto which engages with an electrical connector. Ends of the strut are flatted to form integral planar mounting flanges for mounting the hitch to a vehicle.

### RELATED APPLICATIONS

This application is a continuation-in-part of U.S. Ser. No. 09/694,590 entitled “Trailer Hitch” filed Oct. 23, 2000 and claims the benefit of U.S. Provisional Application No. 60/329,799 filed Oct. 16, 2001 entitled “Lightweight Trailer Hitch with Integral Electrical Connector System”.

### FIELD OF THE INVENTION

The present invention relates to vehicle trailer hitches, more particularly to a two component trailer hitch, the strut and receiver of which both being manufactured from aluminum, to which is attached an electrical connector.

### BACKGROUND OF THE INVENTION

Many passenger vehicles, particularly trucks, vans and sport utility vehicles are used to tow a trailer. The trailer is attached to a towing vehicle via a trailer hitch. One common type of trailer hitch is a receiver trailer hitch which includes a generally rectangular shaped tubular receiver in an assembly fixed to the vehicle frame structure. A generally rectangular shaped tongue extending from the trailer is mounted inside the receiver. The trailer hitch communicates the pulling, turning and braking forces from the towing vehicle to the trailer. Trailer hitches must bear a significant load and are designed for both functionality and aesthetics. In view of the strength and safety requirements of trailer hitches, a conventional 10,000-pound capacity trailer hitch typically weighs about of 35 pounds.

These conventional devices are typically formed from steel and include assembly of numerous components which may number as high as eight or more and which are joined together via arc welding. These heavy trailer hitches are often difficult to manipulate when installing or removing from a vehicle. Moreover, the weight of the trailer hitch adds significantly to the vehicle weight, thus reducing the fuel efficiency of the towing vehicle.

Typical trailer hitches manufactured from steel and having multiple components are disclosed in U.S. Pat. Nos. 3,578,358; 4,032,170; 5,102,156; 5,511,813; 5,620,198 and 5,277,448. Common to the trailer hitches disclosed in each of these patents is a multi-piece structure having an overall U-shaped configuration which is bolted at least at the ends of the U-shaped structure to the towing vehicle. U.S. Pat. No. 5,489,111 discloses a hidden trailer hitch having a curved strut member with mounting flanges attached to the end of the curved structure. U.S. Pat. No. Des. 427,118 discloses a design of elliptical tubes for use in a trailer hitch.

A significant drawback to conventional trailer hitches is the sheer number of components of the trailer hitches. The number of components adds to the complexity in manufacturing and installing the trailer hitch as well as the overall weight of the trailer hitch.

Trailer hitches also require some kind of electrical connector to provide signal and power for the brake lights and turning signals of the towed vehicle or trailer. A common problem with conventional trailer hitches is their proximity to the ground. Electrical components are frequently damaged by various road objects, contact the elements including road salt and water and/or other vehicles.

Accordingly, a need remains for a simple, lightweight vehicle trailer hitch having a minimum number of components and which provides protection to electrical components associated with the trailer hitch.

### SUMMARY OF THE INVENTION

This need is met by the vehicle trailer hitch of the present invention which includes 1) a unitary strut having a pair of integrally formed mounting members positioned at the ends of the strut and 2) a unitary receiver fixed to the strut at a position between the ends of the strut. Preferably, the strut is a U-shaped tubular member manufactured from extruded aluminum alloy having a cross-sectional configuration of an oval or a football-shape, with the mounting members formed at the ends of the tube. The ends of the tube are flattened to provide substantially planar portions. One or more openings are defined in the planar portions for receiving a fastener therethrough to fix the tube to a vehicle. The receiver includes a cast aluminum body preferably welded to the strut. An opening defined in the receiver is configured to receive one end of a trailer. The internal surfaces of the opening may be coated and/or lined with a protective material such as stainless steel or a polymer.

The receiver further includes a pair of spaced apart brackets extending from the top of the receiver body. The brackets each include a flange having an arcuately shaped attachment surface which abuts the exterior surface of the tube. A support member extends from the bottom of the receiver body and includes an elongated support surface is disposed on an opposing side of the tube from the arcuately shaped attachment surfaces.

The receiver may directly engage with a connector assembly for communicating with an electrical system of a towed vehicle. The receiver may define a slot, defined by the receiver body and the brackets, for receiving and engaging with the connector assembly. The connector assembly comprises a housing fitted within the slot and an electrical circuit for communicating with the electrical system of a towed vehicle. One aperture in the housing may receive a four-way electrical component in communication with a towed vehicle and another aperture in the housing may receive a seven-way electrical component in communication with a towed vehicle.

The present invention further includes a method of manufacturing a vehicle trailer hitch having the steps of providing a tube having a pair of ends, bending the tube into a U-shape, flattening the ends of the tube to form a pair of substantially planar portions, reforming a portion of the tube between the ends to mate with a trailer receiver and mounting a trailer receiver on the tube at a position between the ends. The step of providing a tube preferably includes extruding an aluminum alloy tube having an oval or football-shaped cross-sectional configuration. A portion of tube is reformed to achieve a cross-sectional configuration which mates with a surface of the receiver. The receiver preferably is manufactured from cast aluminum and is welded to the tube.

### BRIEF DESCRIPTION OF THE DRAWINGS

A complete understanding of the invention will be obtained from the following description when taken in connection with the accompanying drawing figures wherein like reference characters identify like parts throughout.

FIG. 1 is a perspective view of a vehicle trailer hitch made in accordance with the present invention including a tube and a receiver;

FIG. 2 is a cross-sectional view of the tube shown in FIG. 1 taken along line 2-2;

FIG. 3 is a cross-sectional view of the tube shown in FIG. 1 taken along line 3-3;

FIG. 4 is a cross-sectional view of the vehicle trailer hitch shown in FIG. 1 taken along line 4-4;

FIG. 5 is a perspective view of the receiver shown in FIG. 1;

FIG. 6 is a front elevation view of the receiver shown in FIG. 5;

FIG. 7 is a top view of the receiver shown in FIG. 5;

FIG. 8 is a front elevation of the bracket shown in FIG. 5 with an electrical connector mounted therein; and

FIG. 9 is a perspective view of the electrical connector shown in FIG. 8.

### DETAILED DESCRIPTION OF THE PREFERRED EMBODIMENT

For purposes of the description hereinafter, the terms “upper”, “lower”, “right”, “left”, “vertical”, “horizontal”, “top”, “bottom” and derivatives thereof shall relate to the invention as it is oriented in the drawing figures. However, it is to be understood that the invention may assume various alternative variations and step sequences, except where expressly specified to the contrary. It is also to be understood that the specific devices and processes illustrated in the attached drawings, and described in the following specification, are simply exemplary embodiments of the invention. Hence, specific dimensions and other physical characteristics related to the embodiments disclosed herein are not to be considered as limiting.

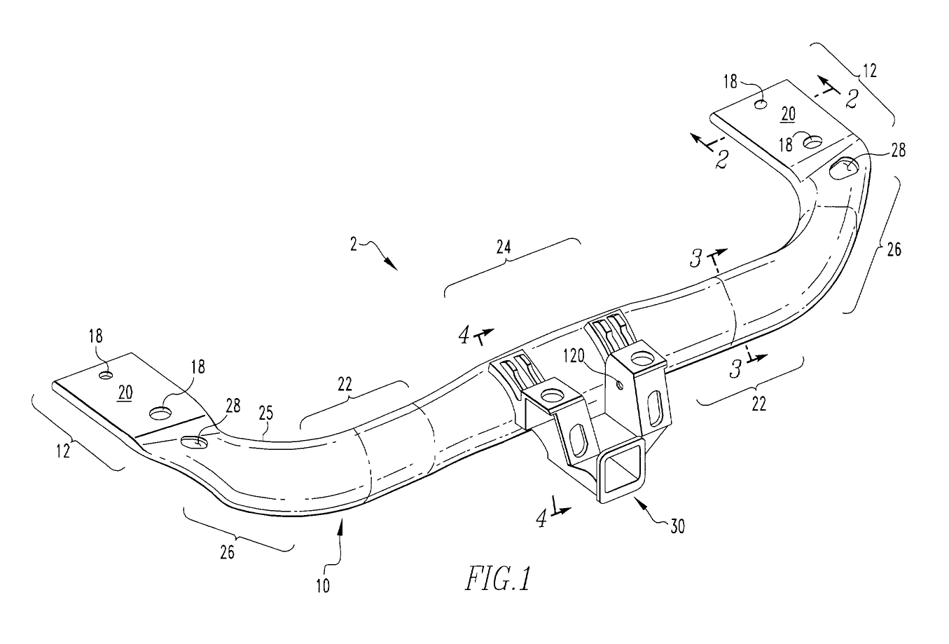

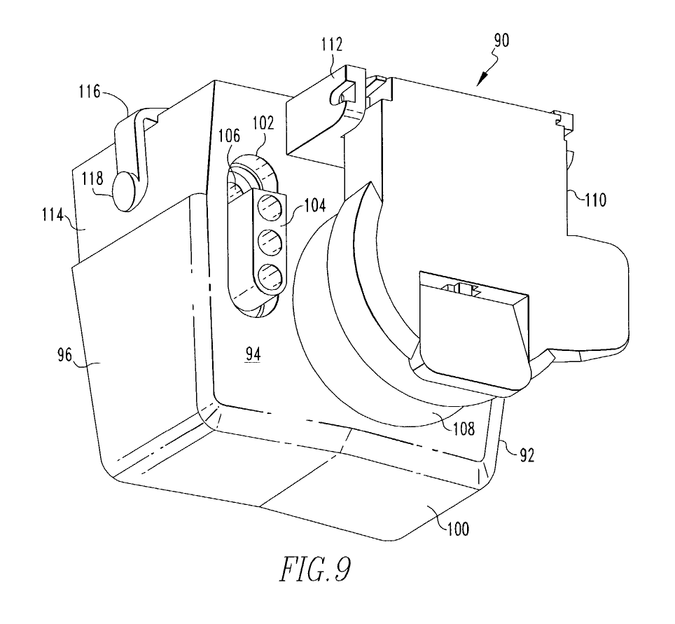

The vehicle trailer hitch 2 of the present invention shown in FIG. 1 includes, in its most basic form, a U-shaped strut 10 and a receiver 30 mounted to the strut 10 with an optional electical connector assembly 90 (FIGS. 8 and 9) fitted within the receiver 30.

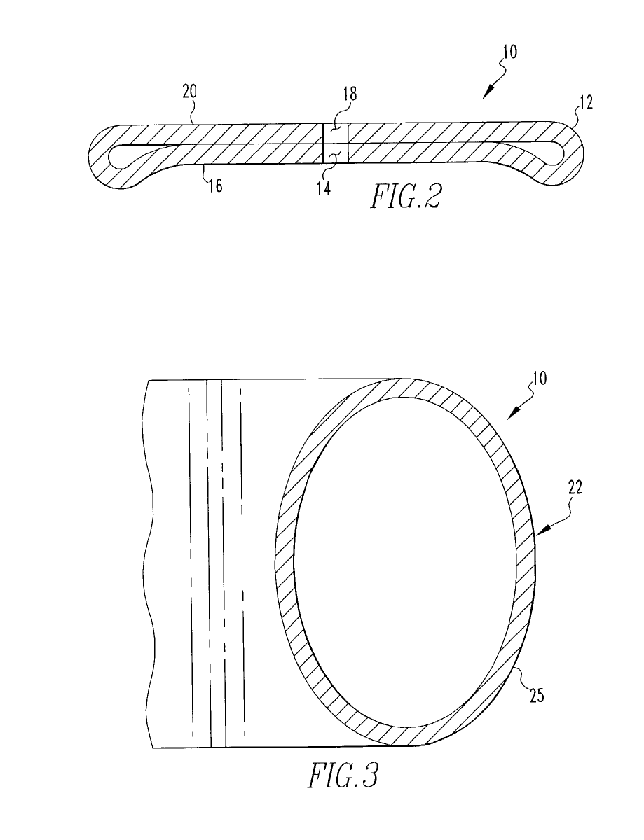

The strut 10 is preferably in the form of a tube having a cross-sectional configuration which varies along its length. The strut 10 preferably is extruded aluminum alloy of the Aluminum Association 6000 series, more preferably alloys 6082, 6063 or 6061, most preferably alloy 6082. The ends of the strut 10 are flattened, e.g. in a press, to form one embodiment of a cross-sectional configuration shown in FIG. 2, thereby creating integrally formed mounting members 12. It is to be understood that other embodiments and/or cross-sectional configurations for the strut 10 are included herein. The mounting members 12 may have other configurations yet be integrally formed with the strut 10. The mounting members 12 each define at least one, preferably two, holes 14 in an underside 16 thereof and a corresponding number of holes 18 in an upper side 20. Preferably, the holes 14 and 18 have the same or similar dimensions, although one set of one holes 14 and 18 may have different dimensions from another set of holes 14 and 18. Each set of one hole 14 and one hole 18 is aligned to receive a fastener (not shown) therethrough. Preferably, a headed bolt or the like seats on the underside 16 of the mounting members 12 and the shank of the bolt extends through the holes 14 and 18 and into the underside of a vehicle (not shown) to mount the hitch 2 to the vehicle.

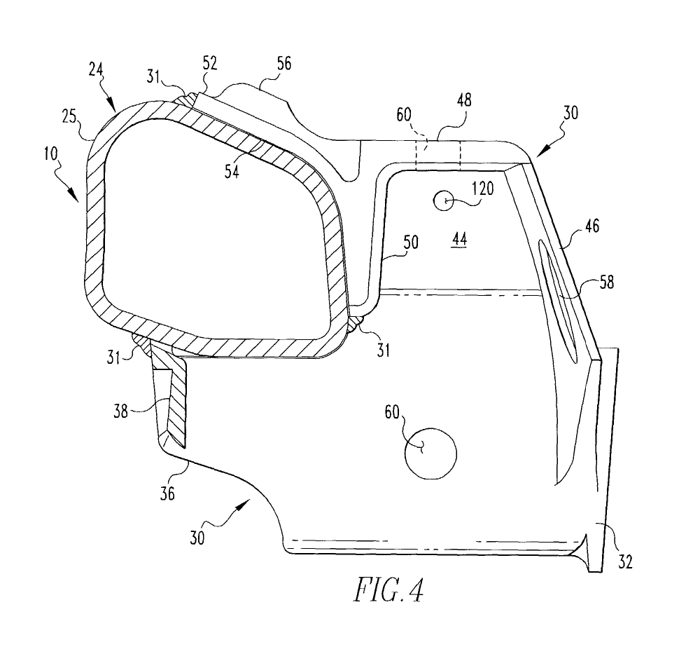

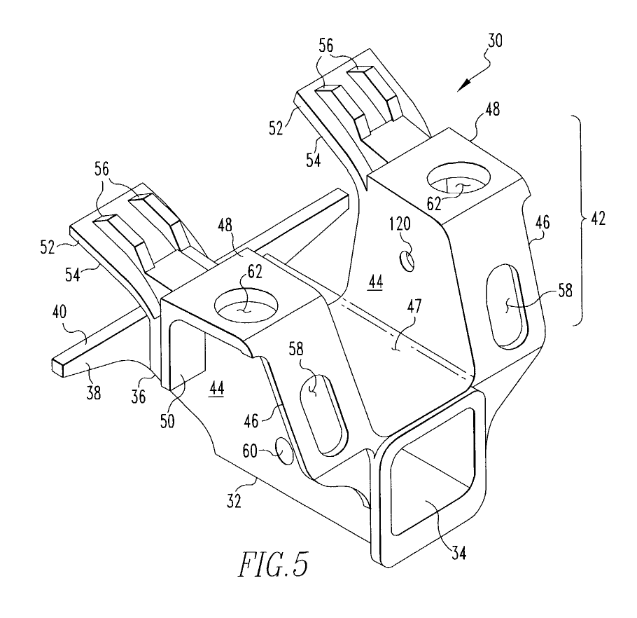

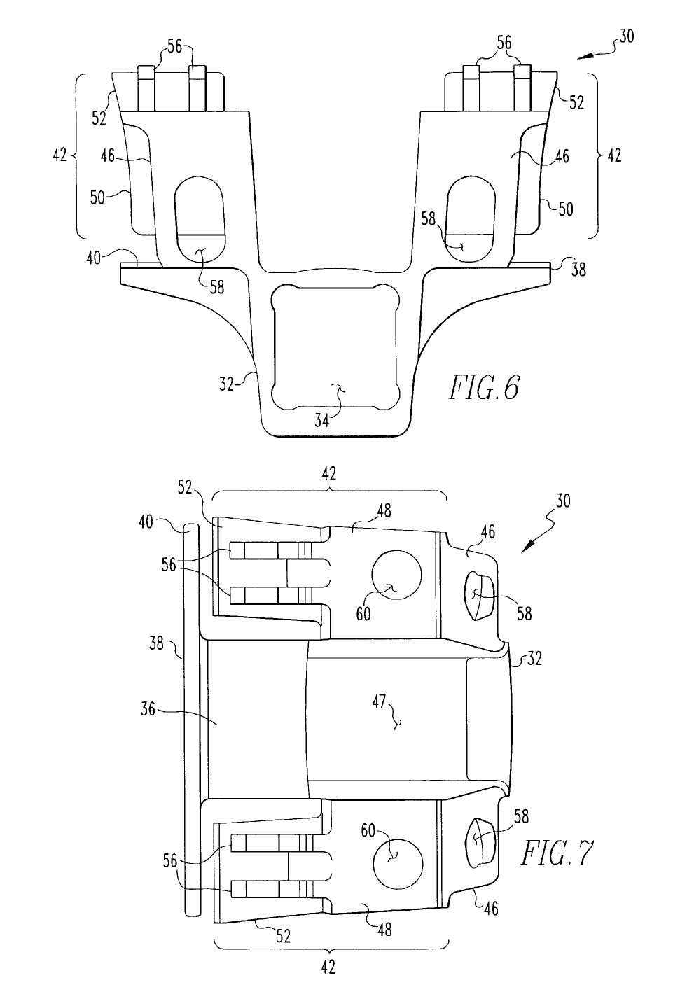

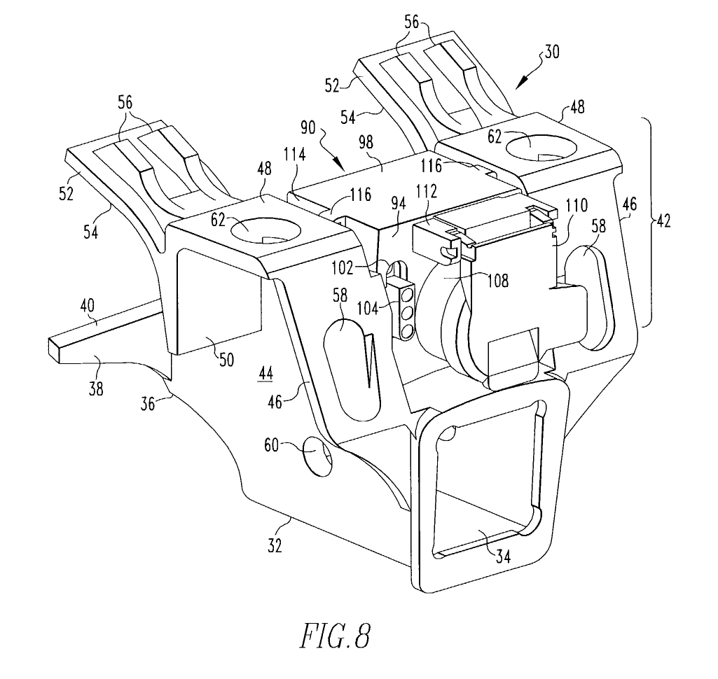

An intermediate portion 22 of the strut 10 has a generally oval or football-shaped cross-sectional configuration as shown in FIG. 3, and a central portion 24 of the strut 10 has an irregular cross-sectional configuration as shown in FIG. 4 in the location of the receiver 30. Preferably, the strut 10 is extruded as a straight tube having a wall 25 and a football-shaped cross-sectional configuration. The ends are flattened to form the mounting members 12, and the tube is bent into a U-shape forming curved portions 26.

Referring to FIG. 1, the wall 25 of the strut 10 may further define one or more openings 28 through a single thickness of the wall 25. The openings 28 are positioned and sized to accommodate downwardly extending structures on the underside of a vehicle which would otherwise interfere with the positioning of the strut 10 against the under side of the vehicle.

The wall 25 of the strut 10 is deformed as shown in FIG. 4 from the extruded cross-sectional configuration shown in FIG. 3 to permit mounting of the receiver 30 to the central portion 24 of the strut 10. The receiver 30 is preferably fixed to the central portion 24 of the strut 10 via welding as shown at reference numerals 31. The cross-sectional configuration of the central portion 24 of the strut 10 achieves an acceptable mating relationship between the strut 10 and the receiver 30.

Referring to FIG. 5, the receiver 30 includes a unitary body 32 which defines a socket opening 34 for receiving the tongue member of a trailer (not shown). The receiver preferably is manufactured from cast aluminum of the Aluminum Association 3xx series, more preferably alloy A356. An inner surface of the socket opening 34 is preferably lined with a plasma sprayed composition such as stainless steel to provide wear resistance and corrosion resistance to the aluminum receiver 30. An arm 36 extends from the body 32 on an opposite side thereof from the socket opening 34. An elongated flange 38 extends from the arm 36 and includes a strut support surface 40. Preferably, the central portion 24 is welded to the strut support surface 40 of the receiver 30. One or more brackets 42 extend from an upper side of the receiver 30 and include a wall 44. A sloped ledge 46 extends from one side of the wall 44. The walls 44 and body 32 together define a slot 47. A generally horizontal ledge 48 extends from a topside of the wall 44, and a generally vertical ledge 50 extends from a rear side of the wall 44. An arcuately shaped flange 52 extends from the vertical ledge 50 and includes a strut receiving surface 54 on an underside of the ledge 50 and at least one, preferably two, ribs 56 formed in an upper surface thereof. Each sloped ledge 46 defines an opening 58 for receiving safety chains and the like of a trailer (not shown), and each wall 44 defines an opening 60 for receiving a trailer hitch pin (not shown). A mounting hole 62 is defined in the horizontal ledge 48. A bolt (not shown) may extend from an underside of the ledge 48, through the hole 62 and into the underside of a vehicle (not shown) to further secure the hitch 2 to the vehicle.

Referring to FIG. 8, the receiver 30 may engage with an electrical connector assembly 90 shown in more detail in FIG. 9. Suitable electrical connectors are described in U.S. patent application Ser. No. 09/862,213, filed May 23, 2001, entitled “A Combined Four Way and Seven Way Connector Assembly For Use With a Vehicle and For Accommodating a Trailer Tow Package”, incorporated herein by reference. The electrical connector assembly 90 shown in FIGS. 8 and 9 is one example of such a suitable device. Assembly 90 includes a housing 92 containing appropriate electrical circuits (not shown) for electrical communication between a vehicle on which the trailer hitch 2 is mounted and the vehicle (such as a trailer) being towed. Housing 92 includes a face 94, a pair of side walls 96 (only one being shown), an upper wall 98 and a lower wall 100. Face 94 defines a slot 102 through which three-way electrical contact 104 extends and through which electrical contact 106 is accessible. An annular member 108 extends from the housing face 94 and surrounds alternate electrical contacts, not shown. A lid 110 fixed to the housing 92 via hinge assembly 112 is configured to cover the opening of the annular member 108 when the alternate electrical contacts are not in use. Side walls 96 define upper recessed portions 114. Fastening members 116, shown in FIG. 9 as L-shaped members, extend from upper walls 98 of the housing 92. The fastening members 116 terminate in enlarged portions 118. The fastening members 116 may be flexible such that the enlarged portions 118 are movable towards and away from the recessed portions 114 of side walls 96. The walls 44 each define an opening 120 such as a hole for receiving the enlarged portion 118 therethrough. The opening 120 may extend partially or completely through the wall 44. Lower wall 100 may be V-shaped. The connector assembly 90 is sized so that the side walls 96 are tightly fitted within slot 47 of the receiver 30. Fastening members 116 are configured such that enlarged portions 118 fit within the openings 120 in the walls 44 to further ensure that the connector assembly 90 fits tightly within the slot 47. The housing 92 with fastening members 116, electrical contact 104, lid 110 and hinge assembly 112 may be made from a plastic or other such material that resists environmental damage (e.g. salt and dirt) while protecting the electrical circuits therein. In addition, by locating the connector assembly 90 within the slot 47, the connector assembly 90 is protected by the body 32, the walls 44 as well as the strut 10, as well as the underside of the vehicle when mounted thereto.

Having described the presently preferred embodiments, it is to be understood that the invention may be otherwise embodied within the scope of the appended claims.

What is claimed is:

1. A vehicle trailer hitch comprising:
a unitary strut having a pair of integrally formed mounting members positioned at the ends of said strut, said mounting members being configured to mount said strut to a towing vehicle;
a unitary receiver fixed to said strut at a position between said mounting members, said receiver defining an opening for receiving one end of a vehicle trailer; and
a connector assembly for communicating with an electrical system of a towed vehicle, said connector assembly being engaged with said receiver.

2. The vehicle trailer hitch of claim 1 wherein said receiver defines a slot for receiving and engaging with said connector assembly.

3. The vehicle trailer hitch of claim 2 wherein said receiver comprises a body portion and a pair of spaced apart brackets, said slot being defined between said brackets.

4. The vehicle trailer hitch of claim 3 wherein each said bracket includes a wall defining an opening for receiving and engaging with said connector assembly.

5. The vehicle trailer hitch of claim 4 wherein said connector assembly includes a fastening member having an end received within one said opening.

6. The vehicle trailer hitch of claim 5 wherein said fastening member is flexible.

7. The vehicle trailer hitch of claim 5 wherein said fastening member extends from an upper portion of said electrical connector.

8. The vehicle trailer hitch of claim 4 wherein said connector assembly includes a pair of fastening members, each fastening member having an end received within one said opening.

9. The vehicle trailer hitch of claim 3 wherein said receiver further comprises a pair of flanges extending from said brackets, each said flange having a strut receiving surface abutting said strut.

10. The vehicle trailer hitch of claim 9 wherein said flanges each include a reinforcing rib.

11. The vehicle trailer hitch of claim 9 wherein said receiver further comprises a support member extending from said body and supporting said strut on an opposing side of said strut from said strut receiving surface.

12. The vehicle trailer hitch of claim 1 wherein said strut comprises an extruded tube and said mounting members comprise substantially planar, integrally extruded tapered ends.

13. The vehicle trailer hitch of claim 2 wherein said connector assembly comprises a housing fitted within said slot and an electrical circuit for communicating with the electrical system of a towed vehicle.

14. The vehicle trailer hitch of claim 13 wherein said housing defines an aperture for receiving electrical components in communication with a towed vehicle and said electrical circuit.

15. The vehicle trailer hitch of claim 13 wherein said housing includes a first aperture for receiving a four-way electrical component in communication with a towed vehicle and a second aperture for receiving a seven-way electrical component in communication with a towed vehicle.
